(19) United States
(12) Patent Application Publication
(10) Pub. No.: US 2006/0132978 A1
(43) Pub. Date: Jun. 22, 2006

(54) Slider for high density magnetic recording

(76) Inventors: Hong Tian, Tai Po (HK); Takehiro Kamigama, Kowloon (HK); Ellis T. Cha, San Ramon, CA (US)

Correspondence Address: KENYON & KENYON LLP, RIVERPARK TOWERS, SUITE 600, 333 W. SAN CARLOS ST., SAN JOSE, CA, 95110, US

(21) Appl. No.: 11/340,161

(22) Filed: Jan. 26, 2006

Related U.S. Application Data
(63) Continuation-in-part of application No. 10/823,930, filed on Apr. 14, 2004.

(51) Int. Cl. G11B 5/60

(52) U.S. Cl. 360/235.8

(57) ABSTRACT

An improved slider design is disclosed. The width of the slider is less than 0.7 mm. The slider may have a thickness of 0.18 mm and a length of 0.85 mm. The air-bearing surface of the slider may have a two-tiered U-shaped rail on the leading edge. A two-tiered main compression pad, straddled by two outlying compression pads, may extend from the trailing edge of the air-bearing surface.

### BACKGROUND INFORMATION

This application is a continuation-in-part of application Ser. No. 10/823,930, filed Apr. 14, 2004, the disclosure of which is incorporated herein in its entirety.

The present invention relates to magnetic hard disk drives. More specifically, the present invention relates to the shape and size of the slider of a head gimbal assembly.

Hard disk drives are common information storage devices essentially consisting of a series of rotatable disks that are accessed by magnetic reading and writing elements. These data transferring elements, commonly known as transducers, are typically carried by and embedded in a slider body that is held in a close relative position over discrete data tracks formed on a disk to permit a read or write operation to be carried out. In order to properly position the transducer with respect to the disk surface, an air bearing surface (ABS) formed on the slider body experiences a fluid air flow that provides sufficient lift force to “fly” the slider and transducer above the disk data tracks. The high speed rotation of a magnetic disk generates a stream of air flow or wind along its surface in a direction substantially parallel to the tangential velocity of the disk. The air flow cooperates with the ABS of the slider body which enables the slider to fly above the spinning disk. In effect, the suspended slider is physically separated from the disk surface through this self-actuating air bearing.

Some of the major objectives in ABS designs are to fly the slider and its accompanying transducer as close as possible to the surface of the rotating disk, and to uniformly maintain that constant close distance regardless of variable flying conditions. The height or separation gap between the air bearing slider and the spinning magnetic disk is commonly defined as the flying height. In general, the mounted transducer or read/write element flies only approximately a few nanometers above the surface of the rotating disk. The flying height of the slider is viewed as one of the most critical parameters affecting the magnetic disk reading and recording capabilities of a mounted read/write element. A relatively small flying height allows the transducer to achieve greater resolution between different data bit locations on the disk surface, thus improving data density and storage capacity. With the increasing popularity of lightweight and compact notebook type computers that utilize relatively small yet powerful disk drives, the need for a progressively lower flying height has continually grown.

As shown in FIG. 1 an ABS design known for a common catamaran slider 5 may be formed with a pair of parallel rails 2 and 4 that extend along the outer edges of the slider surface facing the disk. Other ABS configurations including three or more additional rails, with various surface areas and geometries, have also been developed. The two rails 2 and 4 typically run along at least a portion of the slider body length from the leading edge 6 to the trailing edge 8. The leading edge 6 is defined as the edge of the slider that the rotating disk passes before running the length of the slider 5 towards a trailing edge 8. As shown, the leading edge 6 may be tapered despite the large undesirable tolerance typically associated with this machining process. The transducer or magnetic element 7 is typically mounted at some location along the trailing edge 8 of the slider as shown in FIG. 1. The rails 2 and 4 form an air bearing surface on which the slider flies, and provide the necessary lift upon contact with the air flow created by the spinning disk. As the disk rotates, the generated wind or air flow runs along underneath, and in between, the catamaran slider rails 2 and 4. As the air flow passes beneath the rails 2 and 4, the air pressure between the rails and the disk increases thereby providing positive pressurization and lift. Catamaran sliders generally create a sufficient amount of lift, or positive load force, to cause the slider to fly at appropriate heights above the rotating disk. In the absence of the rails 2 and 4, the large surface area of the slider body 5 would produce an excessively large air bearing surface area. In general, as the air bearing surface area increases, the amount of lift created is also increased. Without rails, the slider would therefore fly too far from the rotating disk thereby foregoing all of the described benefits of having a low flying height.

As illustrated in FIG. 2, a head gimbal assembly 40 often provides the slider with multiple degrees of freedom such as vertical spacing, or pitch angle and roll angle which describe the flying height of the slider. As shown in FIG. 2, a suspension 74 holds the HGA 40 over the moving disk 76 (having edge 70) and moving in the direction indicated by arrow 80. In operation of the disk drive shown in FIG. 2, an actuator 72 (such as a voice-coil motor (VCM)) moves the HGA over various diameters of the disk 76 (e.g., inner diameter (ID), middle diameter (MD) and outer diameter (OD)) over arc 75.

Reducing the size of the slider allows for lower flying heights at lower production costs. The smaller slider size may create a smaller air-bearing surface area, lowering the flying height. The smaller slider size also means that more sliders can be produced on a wafer. One version of a slider has a size of 1 mm to 3.0 mm in length, 1 mm to 2.5 mm in width, and less than 0.65 mm in thickness. FIG. 3a illustrates the current industry standard “PICO” slider size. The PICO slider is 1.25 mm in length 310, 1 mm in width 320, and 0.3 mm in thickness (not shown). Recently, the International Disk Drive Equipment and Materials Association (IDEMA) have standardized a “FEMTO” slider, as shown in FIG. 3b. The FEMTO slider is 0.85 mm in length 330, 0.7 mm in width 340, and 0.23 mm in thickness (not shown). The new FEMTO slider standard allows more sliders to be made out of a single wafer. However, the small size compromises the air-bearing stiffness required to counteract the external forces, and thus creating difficulties in maintaining minimal variations in flying height. Also, the smaller ABS area on a FEMTO slider means the air-bearing is less stiff to counteract the external forces arising from the manufacturing tolerances and environmental conditions as well.

### DESCRIPTION OF THE DRAWINGS

FIG. 1 is a perspective view of a slider device with a read/write head that is known in the art.

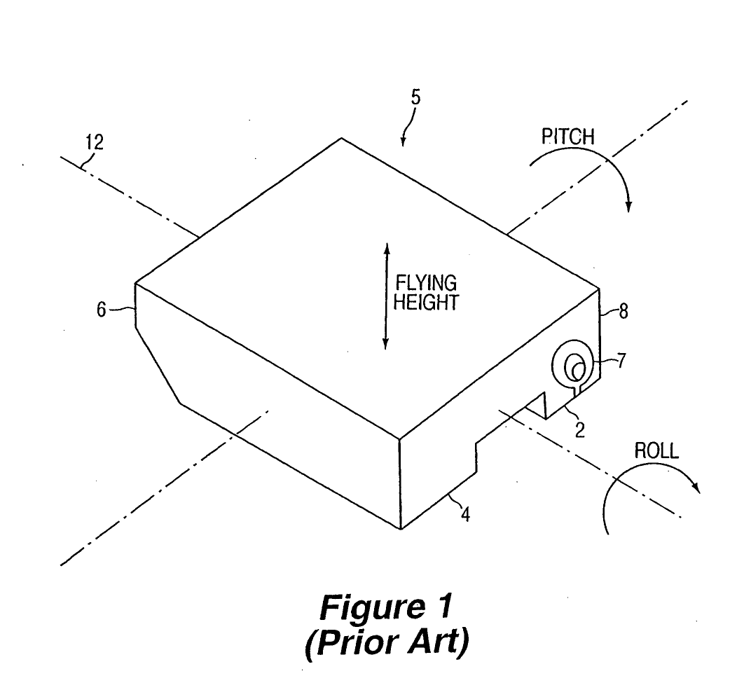

FIG. 2 is a perspective view of a disk drive device that is known in the art.

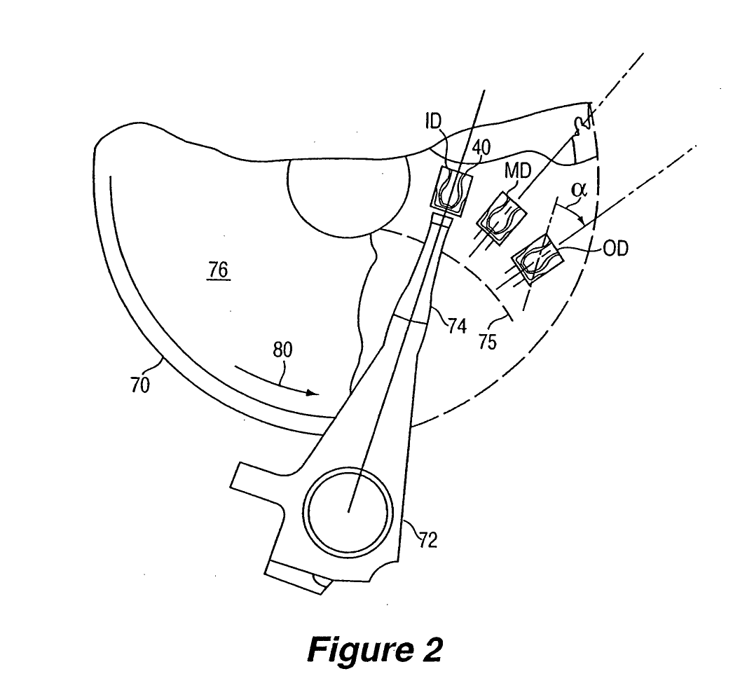

FIGS. 3a-b provide an illustration of one embodiment of a FEMTO slider and a PICO slider, as known in the prior art.

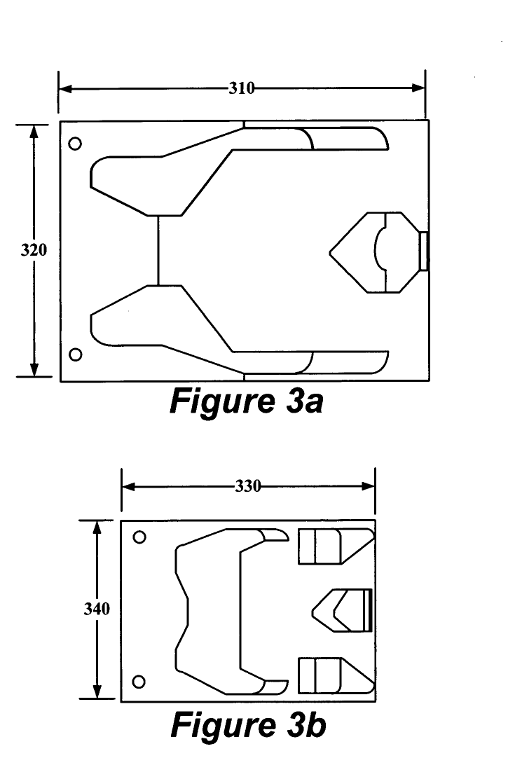

FIG. 4 provides an illustration of one embodiment of a slider according to the present invention.

FIGS. 5a-b compare in table format the air-bearing stiffness matrix as a percentage of a PICO slider stiffness for a slider of the present invention with the air-bearing stiffness matrix as a percentage of a PICO slider stiffness for a FEMTO slider.

### DETAILED DESCRIPTION

An improved slider design is disclosed. The width of the slider is less than 0.7 mm. The slider may have a thickness of 0.18 mm and a length of 0.85 mm. The air-bearing surface (ABS) of the slider may have a two-tiered U-shaped rail on the leading edge. A two-tiered main compression pad, straddled by two outlying compression pads, may extend from the trailing edge of the ABS.

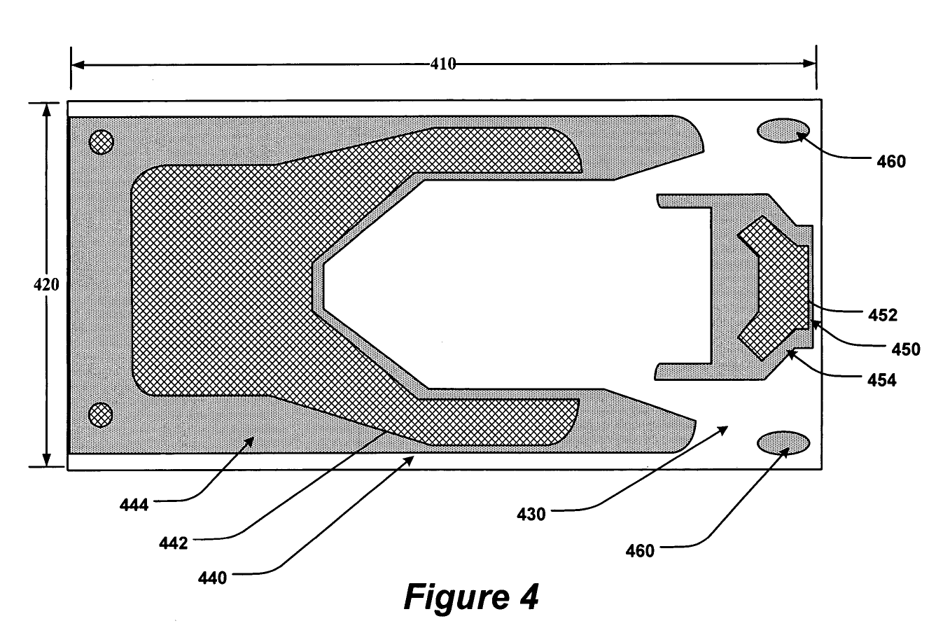

FIG. 4 illustrates one embodiment of a slider according to the present invention. The slider, referred to as a PEMTO slider, may have a length 410 of 3.0 mm or less, a width 420 of 1.0 mm or less, and a thickness (not shown) of 0.23 mm or less. In this embodiment, the length of the slider may be longer than the maximum length (0.85 mm) of a standard FEMTO slider. In one embodiment, a slider may have a length 410 of 1.25 mm, a width 420 of 0.7 mm, and a thickness (not shown) of 0.23 mm, creating a FEMTO slider with the length of a PICO slider. The longer length 410 increases the size of the ABS 430, increasing stability. In one embodiment, the length 410 of the ABS is between 0.85 mm and 1.25 mm. In one embodiment, the slider is an ATTO slider. The ATTO slider may have a length of 0.85 mm, a width of 0.5 mm, and a thickness of 0.18 mm.

In one embodiment, different features may be added to the ABS 430 to improve the ability of the ABS 430 to “fly” above the surface of the hard disk. A U-shaped rail 440 may extend from the leading edge of the slider on the ABS 430. The U-shaped rail 440 may be two-tiered, having a first surface 442 and a second surface 444 at a different level from the first surface 442. A main compression pad 450 may extend from the trailing edge of the slider on the ABS 430. The main compression pad 450 may be two-tiered, having a first surface 452 and a second surface 454 at a different level from the first surface 452. Two outlying compression pads 460 may straddle the main compression pad 450. The outlying compression pads 460 may be on the same level as the second surface 454 of the main compression pad 450. While the above ABS design is described as an example, any ABS design may be used.

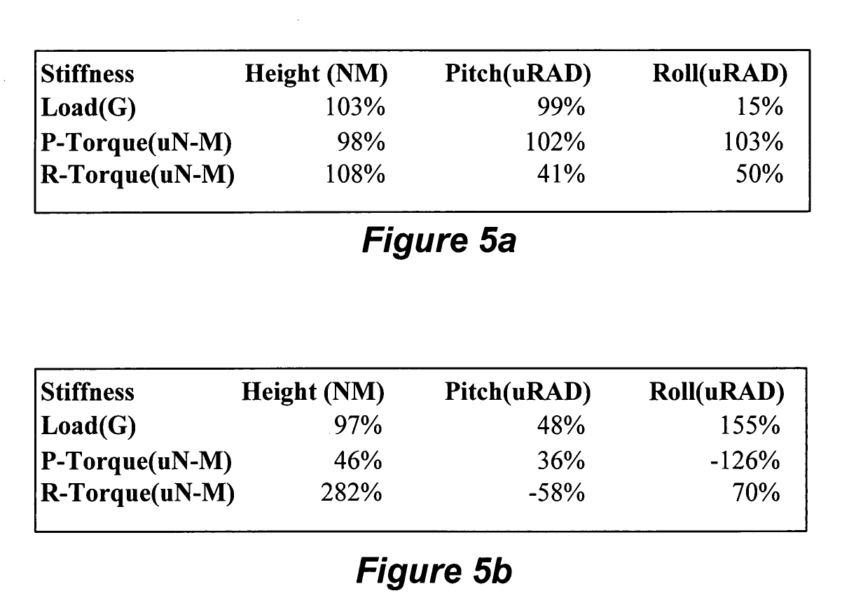

The air-bearing formed between the slider and the rotating disk may be thought of as similar to a very stiff spring. The stiffness of the air-bearing may be a function of the ABS design, ABS area, atmospheric conditions, flying height, and other factors. Counteracting the external forces created by manufacturing tolerances is an important goal in ABS design. As the read/write element is located along the centerline of the slider body at the trailing edge, the external pitch torque has the greatest effect on the allowable flying height tolerance. The two main sources of the pitch torque is the slider alignment and suspension pitch-static-attitude (PSA) tolerance. FEMTO slider flying height is especially vulnerable to the changes in pitch torque because of its shorter length. The slider length of this embodiment provides more leverage to counteract the external pitch torque resulting in lower flying height variation. FIGS. 5a-b compare in table format the air-bearing stiffness matrix as a percentage of a PICO slider stiffness for a slider of the present invention with the air-bearing stiffness matrix as a percentage of a PICO slider stiffness for a FEMTO slider. FIG. 5a compares the pitch stiffness of a slider of the present invention with the pitch stiffness a PICO slider. FIG. 5b compares the pitch stiffness of a FEMTO slider with the pitch stiffness a PICO slider.

Although several embodiments are specifically illustrated and described herein, it will be appreciated that modifications and variations of the present invention are covered by the above teachings and within the purview of the appended claims without departing from the spirit and intended scope of the invention.

1. A slider, comprising:
a body with a width smaller than 0.7 mm; and
an air-bearing surface to allow the slider to glide above a moving data storage medium.

2. The slider of claim 1, wherein the body has a thickness of 0.18 mm or smaller.

3. The slider of claim 1, wherein the length of the body is 0.85 mm or greater.

4. The slider of claim 1, wherein the length of the body is 3.0 mm or smaller.

5. The slider of claim 1, wherein the width of the body is 0.5 mm or greater.

6. The slider of claim 1, further comprising a U-shaped rail extending from the air-bearing surface proximately located to a leading edge of the air-bearing surface.

7. The slider of claim 1, further comprising:
a main compression pad extending from the air-bearing surface proximately located to a trailing edge of the air-bearing surface; and
two outlying compression pads straddling the main compression pad.

8. A disk drive, comprising:
a data storage disk;
a slider with a width smaller than 0.7 mm and an air-bearing surface to allow the slider to glide above the data storage disk when moving; and
a head gimbal assembly to suspend the slider above the data storage medium.

9. The disk drive of claim 8, wherein the slider has a thickness of 0.18 mm or smaller.

10. The disk drive of claim 8, wherein the length of the slider is 0.85 mm or greater.

11. The disk drive of claim 8, wherein the length of the slider is 3.0 mm or smaller.

12. The disk drive of claim 8, wherein the width of the slider is 0.5 mm or greater.

13. The disk drive of claim 8, wherein a U-shaped rail extends from the air-bearing surface proximately located to a leading edge of the air-bearing surface.

14. The disk drive of claim 8, wherein a main compression pad extends from the air-bearing surface proximately located to a trailing edge of the air-bearing surface and two outlying compression pads straddle the main compression pad.

15. A method, comprising:
forming a plurality of sliders on a single wafer; and
dicing the wafer to produce the plurality of sliders each with a width smaller than 0.7 mm.

16. The method of claim 15, wherein the slider has a thickness of 0.18 mm or smaller.

17. The disk drive of claim 8, wherein the length of the slider is 0.85 mm or greater.

18. The method of claim 15, wherein the length of the slider is 3.0 mm or smaller.

19. The method of claim 15, wherein the width of the slider is 0.5 mm or greater.
